(19) United States
(12) Patent Application Publication
(10) Pub. No.: US 2020/0281179 A1
(43) Pub. Date: Sep. 10, 2020

(54) FISH HOOK

(71) Applicant: Jason Sattler, Calliope (AU)

(72) Inventor: Jason Sattler, Calliope (AU)

(21) Appl. No.: 16/809,537

(22) Filed: Mar. 4, 2020

(30) Foreign Application Priority Data
Mar. 5, 2019 (AU) 2019900720
Feb. 27, 2020 (AU) 2020100294

(51) Int. Cl. A01K 83/04; A01K 85/00

(52) U.S. Cl. CPC A01K 83/04; A01K 85/00

(57) ABSTRACT

A fish hook with a plurality of inwardly facing prongs and a shaft to join the prongs, where the shaft and prongs are held by a flexible hub which allows the prongs to move. Each prong can hold a different type of bait. This means that the fisherman can conduct three bait experiments simultaneously. A fisherman using a conventional hook would be required to cast that hook three separate times with different baits to achieve the same test. Accordingly, the improved hook makes fishing more efficient.

### TECHNICAL FIELD

The present invention relates to the fishing industry and, more particularly to a new and improved form of fish hook.

### BACKGROUND

Currently available hooks, including standard hooks, treble hooks, umbrella hooks and double hooks, all have a common problem of snagging. Snagging occurs when the hook catches on an obstruction on the seabed. When reeling in a fishing line, the snagged hook can cause the line to break, resulting in lost tackle. Replacing the lost tackle takes time away from fishing, which decreases the chance of actually catching a fish. Catching obstructions on the sea floor can also provide a false expectation that a fish is on the line, which disappoints the fisherman. Lost tackle, such as lead weights, also pollute the environment.

Another problem is that fish can remove the bait without being caught, leaving the hook empty and unable to catch a fish. Fish are often good at removing bait from a hook without getting the hook caught in their mouth. After a fish takes a few bites of the bait, the fisherman will have to reel in the line to rebait the hook. This reduces fishing time. Further time is wasted whilst the fisherman waits for a fish to locate the baited hook once again.

Fish will often swallow the hook when caught. This makes it difficult and time consuming to remove the hook. Removing the hook badly injures the fish, which is undesirable if the fisherman intends to release the fish.

Fisherman often add a sinker to the line to increase the distance that the line can be cast. Sinkers are typically made of lead. Lead is toxic for both the fisherman and the environment. Sinkers add an expense to the fisherman's equipment. Fish often prefer a light line that has less weight, as it makes the baited hook move more naturally in the water.

Standard hooks can only take one type of bait. That type of bait may not be the preferred bait of fish in that area. Fisherman often have to try different baits until they find an effective bait. If the wrong bait is used initially, fishing time is wasted. Reeling in and re-casting the line with different types of bait takes time, which decreases the chance of catching a fish in the time available.

Another problem is that standard hooks can be dangerous as people can easily get caught on the them.

Standard hooks lay on the sea floor, so that the bait is often obscured by debris or mud. This makes it harder for the fish to find, as the bait is insufficiently prominent.

Furthermore, hooks with multiple prongs are difficult to package and sell, as they take up a significant amount of volume because of the spread of the prongs. The greater the size of the package for the hooks, the greater the amount that the hook costs to post in the mail to customers. The greater the cost of postage, the less attractive the overall price of each hook becomes. Therefore, an effective means of cheaply packaging hooks with multiple prongs is required.

In addition, the greater the size of the overall hook with multiple prongs, the greater the shelf space is required to retail the hook in shops. Shelf space is valuable to retailers.

The objects of the present invention are to provide a hook which is not easily snagged, does not require a sinker, which is difficult for the fish to completely swallow, can take multiple different types of bait simultaneously, is more conspicuous on the sea floor than conventional hooks and can be more efficiently and cost effectively transported to customers in the mail.

### SUMMARY OF THE INVENTION

According to the present invention, there is provided a fish hook comprising multiple inwardly facing prongs and a shaft to join the prongs, wherein the shaft and prongs are held by a flexible hub which allows the prongs to move. Preferably, each prong has an eye through which the shaft is fed. Each prong may penetrate the flexible hub. More preferably, the fish hook has three inwardly facing prongs.

Any of the features described herein can be combined in any combination with any one or more of the other features described herein within the scope of the invention.

### BRIEF DESCRIPTION OF DRAWINGS

Various embodiments of the invention will be described with reference to the following drawings, in which:

FIG. 1 is a side view of a three-pronged hook according an embodiment the present invention.

FIG. 2 is a front view of the hook of FIG. 1.

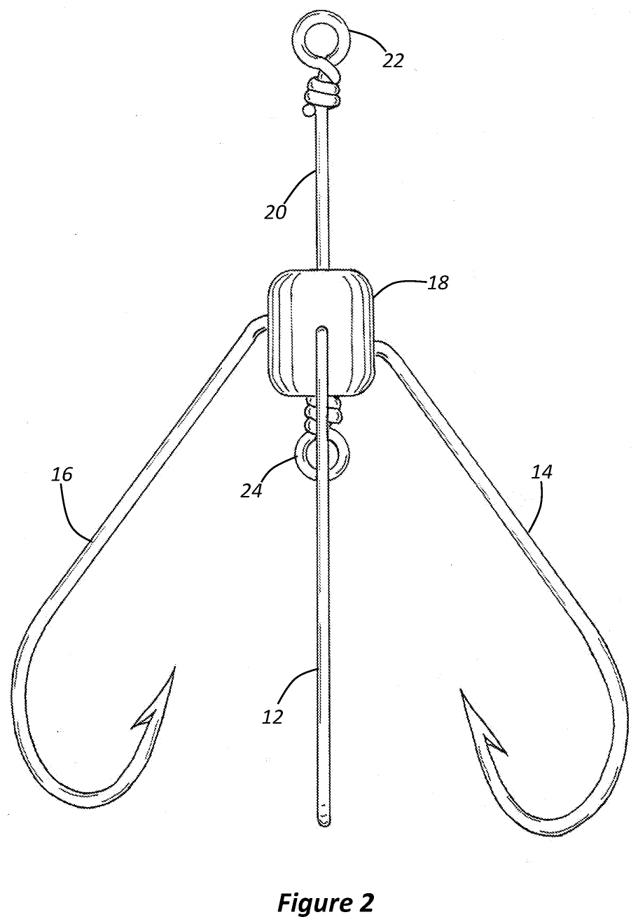

FIG. 3 is a sectioned front view of the hook of FIG. 2.

FIG. 4 is a top view of the hook of FIG. 1.

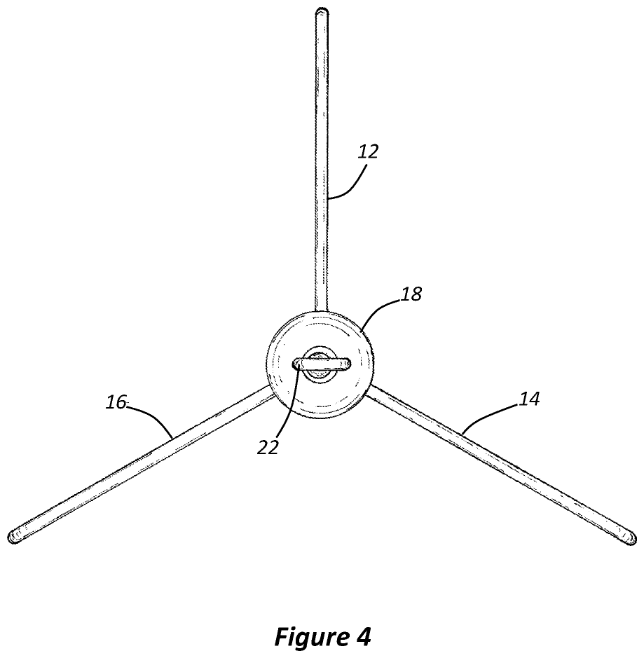

FIG. 5 is a perspective view of the hook of FIG. 1, with a line attached to it.

FIG. 6 is a side view of the hook of FIG. 1 with a prawn lure hub.

FIG. 7 is a side view of the hook of FIG. 1 with a squid lure attached to the bottom hoop of the shaft of the hook.

### DETAILED DESCRIPTION

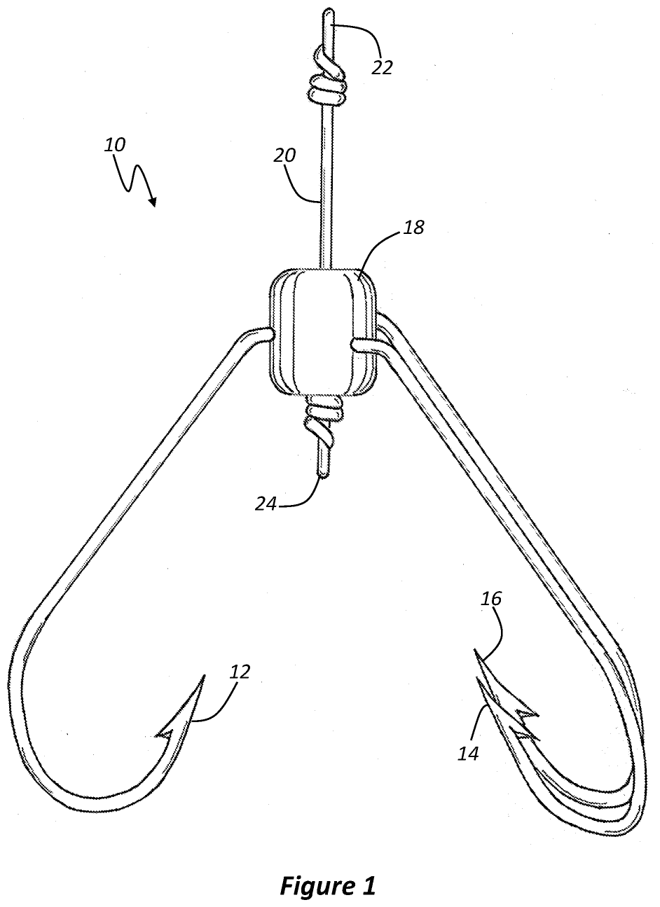

FIG. 1 shows a three-pronged hook 10 according to an embodiment of the present invention. This embodiment comprises three inwardly facing prongs 12, 14 and 16. The hook has a flexible hub 18, which is made of flexible rubber.

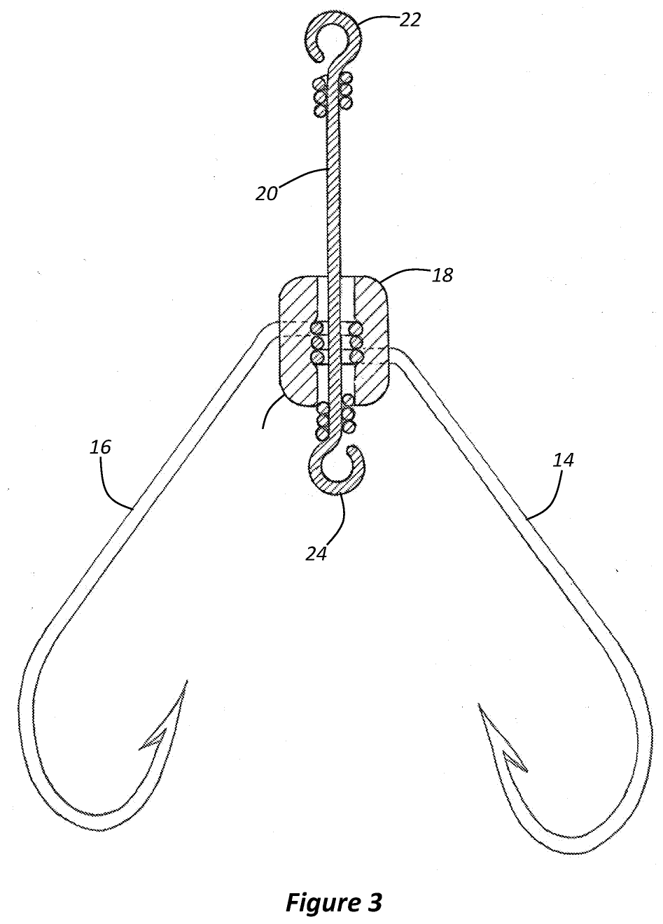

During assembly of the hook, each prong 12, 14 and 16 is fed into the hub 18 and through a side of the hub 18. The point on each prong can pierce the flexible rubber. Each prong is fed through the wall of the hub 18 until the eye of each prong stops the passage of the prong through the wall of the hub. The eyes of each prong are shown in the side section view of FIG. 3.

In other embodiments of the invention, the hub 18 can be a single moulded item of plastic made by 3D printing, or otherwise.

The three prongs 12, 14 and 16 are aligned on top of one another, but the eye of each prong enables it to rotate about central axis.

A shaft 20 is fed through the bottom of the hub 18 and through each of the eyes of the three prongs 12, 14 and 16 (refer to FIG. 3).

Once the shaft 20 has penetrated all three eyes of the prongs 12, 14 and 16, then a hoop 22 is formed on the top of the shaft 20. Another hoop 24 is already on the bottom of the shaft 20.

Each of the hoops 22 and 24 prevent the passage of the shaft 20 out of the hub 18 and the conjoined prongs 12, 14 and 16.

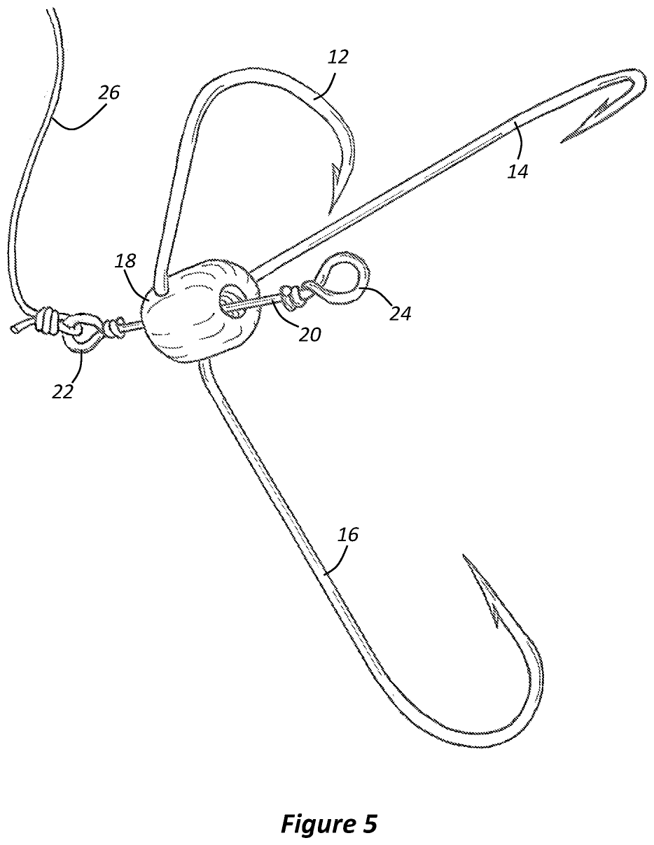

A fishing line 26 can be attached to the upper hoop 22 as shown in FIG. 5. A line can also be attached to the bottom hoop 24.

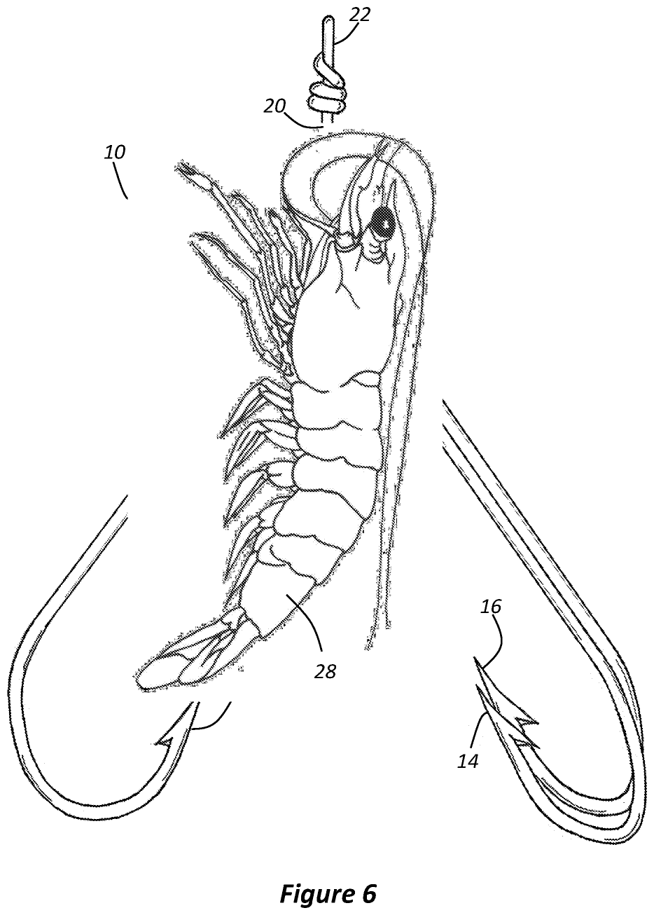

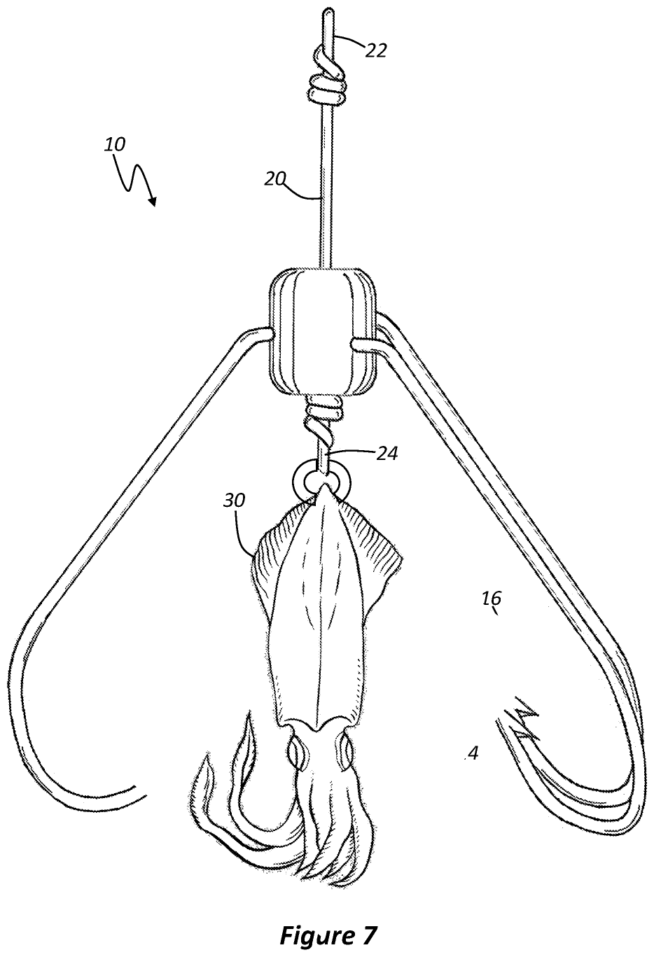

Lures can be placed on the hook 10 to attract fish. FIG. 6 has a prawn shaped lure 28 acting as the hub 18. FIG. 7 has a squid shaped lure 30 attached to the bottom hoop 24 of the hook 10.

The fact that the prongs face inwardly means they are less likely to be caught on the hand of a fisherman. This makes the hook 10 of the present invention safer to use than conventional hooks.

The prongs are equally spaced around the hook so as to allow the fish to easily access the bait on each prong. Because the prongs are equally spaced around the hook, at least one of prongs sits just above the seabed. This makes it easier for fish to identify the uppermost prong with the bait on it. By contrast, conventional hooks have a single prong, which lays on the seabed and can therefore be easily obscured by sand, mud or debris.

Unlike conventional hooks, the prongs 12, 14 and 16 of the hook 10 face inwardly. As a result, as the hook 10 is reeled along the seabed, the prongs 12, 14 and 16 do not face toward the seabed. They face away from the seabed. This decreases the chance that one of the hooks will snare on the seabed. The three-prong design of the present invention is less likely to snag weeds (such as seaweed or river weed) than conventional hooks. This is because the prongs face inwardly.

Each prong can hold a different type of bait. This means that the fisherman can conduct three bait experiments simultaneously. A fisherman using a conventional hook would be required to cast that hook three separate times with different baits to achieve the same test. Accordingly, the hook of the present invention makes fishing more efficient. The more time that the hook can spend in the water, rather than on the land being rebaited, the more chance the fisherman has of successfully catching a fish.

In practice, a fisherman may withdraw a conventional hook with one particular bait, thinking that the bait experiment was unsuccessful. However, in reality, the fisherman may simply have not left the bait in the water for a sufficient amount of time to catch the fish. The premature withdrawal makes the bait experiment fail, when it otherwise would have been successful if the fisherman had been more patient.

The only way conventional hooks could be used to conduct an experiment with three types of bait simultaneously would be if the fisherman used three separate conventional hooks. However, in that instance, the fisherman has three times the chance of getting a snag because of the nature of the design of conventional hooks.

Having too many prongs on a hook can decrease the chance of catching a fish. This is because it becomes harder for the fish to access the internal radius between the prongs.

The multiple (plurality of) prongs increase the overall weight of the hook, which removes the need to add sinkers to the line. Once the hook is in the water, the hook then moves more naturally through the water. By contrast, a sinker makes the bait simply sink to the seabed. The hooks of the present invention thereby present a more appealing target for the fish.

An advantage of the present invention is that as a fish bites on one of the prongs, the other prongs also grab the fish. As the fish bites a first prong, it grabs its mouth. The fish then shakes its head in an attempt to dislodge the first prong. However, by doing so, the fish causes the other prongs to dig into it.

Once the fish is withdrawn from the water, it is relatively easy for the fisherman to withdraw the fish from the hook. Unlike conventional hooks, the fish cannot completely swallow the hooks of the present invention. This causes less damage to the fish, which means that it is more likely to survive if it is released.

The inventor has noticed that the hooks of the present invention tend to come to surface as they are reeled in at a steeper angle than conventional hooks. Conventional hooks tend to drag along the seabed as they are reeled in. However, the hooks of the present invention have the surface area spread out by comparison with conventional hooks. This tends to provide an upward lifting force through the water. As result, the path of the hooks tends toward the vertical. This has the benefit of making the hooks of the present invention less likely to snag, as they are further away from the seabed.

In the present specification and claims, the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A fish hook comprising:
(a) a plurality of inwardly facing prongs; and
(b) a shaft to join the prongs,
wherein the shaft and the prongs are held by a flexible hub which allows the prongs to move.

2. The fish hook of claim 1, wherein each prong has an eye through which the shaft is fed.

3. The fish hook of claim 1, wherein each prong penetrates the flexible hub.

4. The fish hook of claim 2, wherein each prong penetrates the flexible hub.

5. The fish hook of claim 1, in which each prong is aligned in a vertical array within the flexible hub.

6. (canceled)

7. (canceled)

8. The fish hook of claim 2, in which each prong is aligned in a vertical array within the flexible hub.

9. The fish hook of claim 3, in which each prong is aligned in a vertical array within the flexible hub.

10. The fish hook of claim 4, in which each prong is aligned in a vertical array within the flexible hub.

11. The fish hook of claim 1, in which the fish hook has three inwardly facing prongs.

12. The fish hook of claim 2, in which the fish hook has three inwardly facing prongs.

13. The fish hook of claim 3, in which the fish hook has three inwardly facing prongs.

14. The fish hook of claim 4, in which the fish hook has three inwardly facing prongs.

15. The fish hook of claim 1, in which the flexible hub takes the form of a lure.

16. The fish hook of claim 2, in which the flexible hub takes the form of a lure.

17. The fish hook of claim 3, in which the flexible hub takes the form of a lure.

18. The fish hook of claim 4, in which the flexible hub takes the form of a lure.
